(19) United States
(12) Patent Application Publication
(10) Pub. No.: US 2023/0124730 A1
(43) Pub. Date: Apr. 20, 2023

(54) Fracture Geometry And Orientation Identification With A Single Distributed Acoustic Sensor Fiber

(71) Applicant: Halliburton Energy Services, Inc., Houston, TX (US)

(72) Inventors: Zhao Zheng, Houston, TX (US); Timur Mukhtarov, Calgary (CA); Henry Clifford Bland, Calgary (CA)

(73) Assignee: Halliburton Energy Services, Inc., Houston, TX (US)

(21) Appl. No.: 17/501,211

(22) Filed: Oct. 14, 2021

(51) Int. Cl. G01V 1/22; G01V 1/30; E21B 49/00; E21B 43/26

(52) U.S. Cl. CPC G01V 1/226; E21B 43/26; E21B 49/00; G01V 1/30; G01V 2210/65; G01V 2210/1429

(57) ABSTRACT

A method for determining microseismic events. The method may include measuring a seismic travel time of a microseismic event with a fiber optic line disposed in a first wellbore, forming a probability density function for the microseismic event based at least in part on the seismic travel time measurement, modifying the probability density function by applying one or more constraints to form a modified probability density function, identifying one or more most probable source locations from the modified probability density function, and forming a microseismic event cloud from the one or more most probable source locations.

### BACKGROUND

The oil and gas industry may utilize hydraulic fracturing to enhance the permeability of a target subterranean formation by initiating and developing new fractures, or by fluidically connecting to natural or pre-existing fractures. This in turn may increase the productivity of the associated wellbores located therein. There may be an assortment of hydraulic fracturing designs and techniques used to achieve various flow characteristics depending on the geological and petrophysical properties of the target subterranean formation. With respect to the petroleum industry, a target subterranean formation may include a hydrocarbon-bearing reservoir.

Hydraulic fracturing may be used to offset damage to an otherwise acceptably-permeable reservoir caused during the drilling or completing of a wellbore. As a non-limiting example, particulates and fluids from the drilling mud may infiltrate the reservoir at the wellbore interface resulting in a reduction of permeability. Large pressure drops within the immediate wellbore region may be indicative of production restricting damage at the wellbore-reservoir interface. Such damage may be referred to as “skin,” where the severity of the skin may be calculated as a “skin factor,” which increases with damage. Non-limiting examples of hydraulic fracturing operations designed to fluidically bypass this type of damage may include tip screen-out (TSO) designs, Frac-pack designs, and other hydraulic fracturing designs which may utilize high viscosity carrier fluids in conjunction with relatively high mesh proppant sizes. These designs may aim to create one or more high permeability, dominant fractures rather than targeting the creation of smaller fractures.

In other examples, hydraulic fracturing may be used to create flow conduits within what may be considered unconventional subterranean target formations wherein the matrix rock has either low or very low natural permeability (ex: shale, tight sandstone). Such applications may be designed to develop a dendritic-style fracture network with an emphasis on achieving what may be called fracture complexity. The intended result of a hydraulic fracturing design focused on fracture complexity may be to create one or more primary fractures fluidically connected to a multitude of large, medium, small, and micro fractures which function to increase the surface area at the interface between the fracture face and reservoir. In formations or reservoirs with low and ultra-low permeability, there may be a direct relationship between the interfacial surface area between the fracture network and the reservoir, and the productivity of the well located therein.

Regardless of the target fracture geometry, it may be beneficial to have a process or method to model and monitor a hydraulic fracturing operation to ensure that the design objectives are achieved. As such, hydraulic fracturing models may use data gathered during the operation either in real-time, post-operation, or both to monitor, assess, and/or modify a hydraulic fracturing operation with the intention of achieving a specific fracture geometry. In this context, “real-time,” may be construed as monitoring, gathering, and/or assessing data contemporaneously with the execution of an operation. Real-time operations may further comprise modifying the initial design or execution of the planned operation in order to target a specific fracture geometry.

Traditional methodologies may rely on identifying fracture growth and fracture geometry by integrating the wellhead pressure and pump rate into a hydraulic fracturing model. This model, however, may further rely on assumed inputs that aren’t readily known. Additional methodologies are available which may utilize fiber optic technology to record, assess, and monitor acoustic responses from a hydraulic fracturing treatment. The acoustic responses may be known as microseismic events, and they may indicate where a micro fault, micro fracture, micro deformation, or extension of the hydraulic fracture network has occurred. In the case of single fiber monitoring, while the fiber may be able to obtain a probability density function which only indicates microseismic events in the local area. The obtained probability density function may only be able to discern the radial distance of the microseismic events relative to the fiber and may not be able to identify the azimuth of the microseismic events. As a result, the data gathered from a single fiber monitoring system may create a nebulous microseismic event cloud where the location of the microseismic event in 3D space is ambiguous. Therefore, for single fiber microseismic monitoring, the true location of the microcosmic source may not be uniquely pinpointed in a 3D space.

### BRIEF DESCRIPTION OF THE DRAWINGS

These drawings illustrate certain aspects of some examples of the present disclosure and should not be used to limit or define the disclosure.

FIG. 1 illustrates an example of a hydraulic fracturing operation;

FIGS. 2A-2D illustrates a variety of fiber optic installation configurations;

FIG. 3 illustrates is a schematic view of the information handling system;

FIG. 4 illustrates another schematic view of the information handling system;

FIG. 5 illustrates a schematic view of a network;

FIGS. 6A and 6B illustrate a probability density function of a microseismic event measured by fiber optic line;

FIGS. 7A-7D are graphs illustrating a derived microseismic event cloud;

FIG. 8 is a workflow which may be used to locate, monitor, assess, and/or store data pertaining to one or more microseismic events.

FIGS. 9A-9B illustrate graphs that compare information found from the methods described in FIGS. 6A-8.

### DETAILED DESCRIPTION

This disclosure details a method and system for determining the source location of microseismic events and measure fracture geometry. Generally, single fiber monitoring measurements may be limited when determining the source location of microseismic events. The systems and methods discussed below relate to a system and method for modifying obtained probability density functions and determining a fracture geometry while implementing single fiber measurements. To be discussed below are multiple examples which may be applied to modify obtained probability density functions. Modifying obtained probability density functions may convey more information and allow for a visual representation. For example, selected points from the modified probability density function may be in form of a microseismic event cloud.

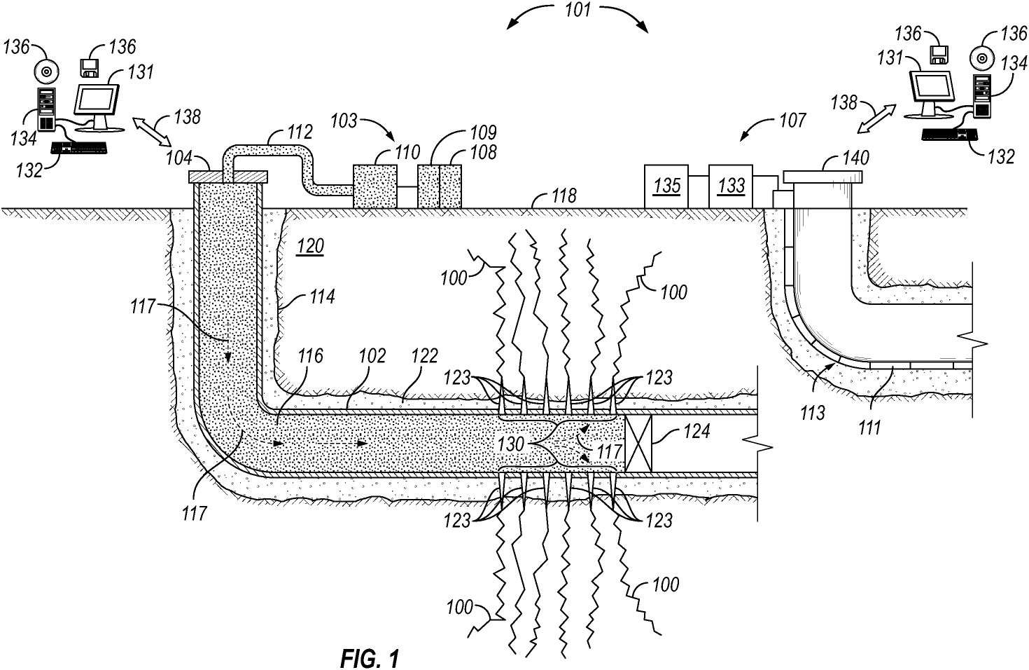

FIG. 1 generally illustrates an example of a well system 101 that may be used to introduce a fracturing fluid 117 which may include a proppant 116 into fractures 100. Well system 101 may include a fluid handling system 103, which may include fluid supply 108, mixing equipment 109, pumping equipment 110, and fluid conduit 112 which fluidically connects the aforementioned equipment to the wellhead 104. Pumping equipment 110 may be fluidly coupled with the fluid supply 108 and wellbore supply conduit 112 to communicate fracturing fluid 117, into hydraulic fracturing wellbore 114. The fluid supply 108 and pumping equipment 110 may be above the surface 118 while the hydraulic fracturing wellbore 114 is below the surface 118.

Well system 101 may also be used for the pumping of a pad or pre-pad fluid into the subterranean formation 120 at a pumping rate and pressure at or above the fracture gradient to create at least one fracture 100 in subterranean formation 120. Well system 101 may then pump fracturing fluid 117 into subterranean formation 120 surrounding the hydraulic fracturing wellbore 114. Generally, a hydraulic fracturing wellbore 114 may include horizontal, vertical, slanted, curved, and other types of wellbore geometries and orientations, and the proppant 116 may generally be applied to subterranean formation 120 surrounding any portion of hydraulic fracturing wellbore 114, including fractures 100. The hydraulic fracturing wellbore 114 may include production casing 102 or set of sliding sleeve assemblies (not pictured) which may be cemented (or otherwise secured by swellable packers or the like) to the wall of the hydraulic fracturing wellbore 114 by cement sheath 122. Production casing 102 may also comprise an uncemented liner.

Perforations 123 may allow communication between the hydraulic fracturing wellbore 114 and the subterranean formation 120. As illustrated, perforations 123 may penetrate production casing 102 and cement sheath 122 allowing communication between interior of casing 102 and fractures 100. A plug 124, which may be any type of plug for oilfield applications (e.g., bridge plug), may be disposed in hydraulic fracturing wellbore 114 below the perforations 123. In accordance with systems and/or methods of the present disclosure, a perforated interval of interest 130 (depth interval of hydraulic fracturing wellbore 114 including perforations 123) may be isolated with plug 124. Alternatively, perforated interval of interest 130 may be isolated by a sleeve or may not be mechanically isolated. A pad or pre-pad fluid may be pumped into the subterranean formation 120 at a pumping rate and pressure at or above the fracture gradient to create at least one fracture 100 in subterranean formation 120. Then, proppant 116 may be mixed with an aqueous based fluid via mixing equipment 109, thereby forming a fracturing fluid 117, and then may be pumped via pumping equipment 110 from fluid supply 108 down the interior of casing 102 and into subterranean formation 120 at or above a fracture gradient of the subterranean formation 120. As previously discussed, proppant 116 may be provided a liquid sand mixture comprising proppant, water, and a gelling agent. Pumping the fracturing fluid 117 at or above the fracture gradient of the subterranean formation 120 may create (or enhance) at least one fracture (e.g., fractures 100) extending from the perforations 123 into the subterranean formation 120.

Alternatively, the fracturing fluid 117 may be pumped down through the production tubing, coiled tubing, or a combination of coiled tubing and annulus between the coiled tubing and the casing 102. At least a portion of the fracturing fluid 117 may enter the fractures 100 of subterranean formation 120 surrounding hydraulic fracturing wellbore 114 by way of perforations 123. Perforations 123 may extend from the interior of casing 102, through cement sheath 122, and into subterranean formation 120.

The pumping equipment 110 may include a high-pressure pump. As used herein, the term “high-pressure pump” refers to a pump that is capable of delivering the fracturing fluid and/or pad/pre-pad fluid downhole at a pressure of about 1000 psi or greater. A high-pressure pump may be used when it is desired to introduce the fracturing fluid 117 and/or pad/pre-pad fluid into subterranean formation 120 at or above a fracture gradient of the subterranean formation, but it may also be used in cases where fracturing is not desired. Additionally, the high-pressure pump may be also capable of fluidly conveying particulate matter, such as the proppant 116, into the subterranean formation 120. Suitable high-pressure pumps may include, but are not limited to, floating piston pumps and positive displacement pumps. Without limitation, the initial pumping rates of the pad fluid, pre-pad fluid and/or fracturing fluid 117 may range from about 15 barrels per minute (“bbl/min”) to about 170 bbl/min, enough to effectively create a fracture into the formation and place the proppant 116 into at least one fracture 100.

Alternatively, the pumping equipment 110 may include a low-pressure pump. As used herein, the term “low pressure pump” refers to a pump that operates at a pressure of about 1000 psi or less. A low-pressure pump may be hydraulically coupled to a high-pressure pump that may be fluidly coupled to a tubular (e.g., wellbore supply conduit 112). The low pressure pump may be configured to convey the fracturing fluid 117 and/or pad/pre-pad fluid to the high pressure pump. The low-pressure pump may “step up” the pressure of the fracturing fluid 117 and/or pad/pre-pad fluid before it reaches the high-pressure pump. Mixing equipment 103 may include a mixing tank that is upstream of the pumping equipment 110 and in which the fracturing fluid 117 may be formulated. The pumping equipment 110 (e.g., a low-pressure pump, a high-pressure pump, or a combination thereof may convey fracturing fluid 117 from the mixing equipment 109 or other source of the fracturing fluid 117 to the casing 102. Alternatively, the fracturing fluid 117 may be formulated offsite and transported to a worksite, in which case the fracturing fluid 117 may be introduced to the casing 102 via the pumping equipment 310 directly from its shipping container (e.g., a truck, a railcar, a barge, or the like) or from a transport pipeline. In either case, the fracturing fluid 117 may be drawn into the pumping equipment 110, elevated to an appropriate pressure, and then introduced into the casing 102 for delivery downhole.

Additionally, well system 101 may be further set up to collect acoustic data by means of a Distributed Acoustic Sensing (DAS) system 107 which may be installed in or connected to one or more offset wellbores. FIG. 1 displays one such offset wellbore as exemplified by fiber wellbore 140. In a non-limiting example, as depicted, DAS system 107 comprises single fiber monitoring whereby a fiber optic line 111 has been installed on the outside of a production casing 102 by one or more cross-coupling protectors 113. Fiber optic line 111 may be single mode, multi-mode, or a plurality thereof. Without limitation, cross-coupling protectors 113 may be evenly spaced and may be disposed on every other joint of production casing 102. As depicted, fiber optic line 111 may be permanently installed and/or temporarily installed in well system 101. Without limitation DAS system 107 may operate and function to measure and produce a record of the monitored microseismic activity from a nearby hydraulic fracturing operation, such as in hydraulic fracturing wellbore 114. Light may be launched into fiber optic line 111 from surface 118 with light returned via the same fiber optic line 111 detected at surface 118. DAS system 107 may detect acoustic energy along fiber optic line 111 from the detected light returned to surface 118. For example, measurement of backscattered light (e.g., Rayleigh backscattering) may be used to detect the acoustic energy. In additional examples, Bragg Grating or other suitable device may be used with the fiber optic line 111 for detection of acoustic energy derived from microseismic events caused by hydraulic fracturing operations. FIG. 1 displays an example implementation of DAS system 107 and fiber optic line 111 in fiber wellbore 140 which is capable of detecting acoustic energy as a subsurface sensory array. It should be understood, however, that alternate examples may include other techniques for detection of acoustic energy from hydraulic fracturing wellbore 114 within well system 101.

With reference to FIG. 1, DAS system 107 may function and operate to measure microseismic events caused by micro faults, micro fractures, micro deformations, or extension of fractures 100 due to hydraulic fracturing operations. Microseismic events may illuminate elements (not illustrated) in subterranean formation 120. Microseismic events may induce a dynamic strain signal in fiber optic line 111, which may be recorded by the DAS system 107 on information handling system 131. Measuring dynamic strain in fiber optic line 111 may include a strain measurement, fiber curvature measurement, fiber temperature measurement, and/or energy of backscattered light measurement. A strain measurement may be performed by an operation of Brillouin scattering (via Brillouin Optical Time-Domain Reflectometry, BOTDR, or Brillouin Optical Time-Domain Analysis, BOTDA), or Rayleigh scattering utilizing Optical Frequency Domain Reflectometry (OFDR). A Fiber curvature measurement may be performed using Polarization Optical Time Domain Reflectometry (P-OTDR) or Polarization- Optical Frequency Domain Reflectometry (P-OFDR). A Fiber temperature measurement may be performed utilizing Raman DTS. An energy of backscattered light of DAS measurement may be performed utilizing an automatic thresholding scheme, the fiber end is set to the DAS channel for which the backscattered light energy flat lines. The purpose of all these measurements may be to compute the structure and properties of subterranean formation 120 at different times. This may allow an operator to perform hydraulic fracture, reservoir, and geomechanically monitoring.

Information handling system 131 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 131 may be a personal computer, a network storage device, or any other suitable device and may vary in size, shape, performance, functionality, and price. Information handling system 131 may include random access memory (RAM), one or more processing resources such as a central processing unit 134 (CPU) or hardware or software control logic, ROM, and/or other types of nonvolatile memory. Additional components of the information handling system 131 may include one or more disk drives 136, output devices 138, such as a video display, and one or more network ports for communication with external devices as well as an input device 132 (e.g., keyboard, mouse, etc.). Information handling system 131 may also include one or more buses operable to transmit communications between the various hardware components.

Alternatively, systems and methods of the present disclosure may be implemented, at least in part, with non-transitory computer-readable media. Non-transitory computer-readable media may include any instrumentality or aggregation of instrumentalities that may retain data and/or instructions for a period of time. Non-transitory computer-readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

Information handling system 131 may be connected to DAS system which may further include a single mode - multimode (“SM-MM”) converter 133 and a DAS interrogator 135. SM-MM converter 133 may be used to convert between a single mode and a multimode for fiber communication. DAS interrogator 135 may be used to emit light pulses into the fiber optic line 111 and translate the backscattered light pulses to digital information, which may be read by information handling system 131. In examples, information handling system 131 may communicate with DAS system 107 and act as a data processing system that analyzes measured and/or collected information. This processing may occur at surface 118 in real-time. Alternatively, the processing may occur at surface 118 and/or at another location. It should be noted that information handling system 131 may be connected to DAS system 107. Without limitation, information handling system 131 may be a hard connection or a wireless connection. Information handling system 131 may record and/or process measurements from DAS system 107 individually and/or at the same time.

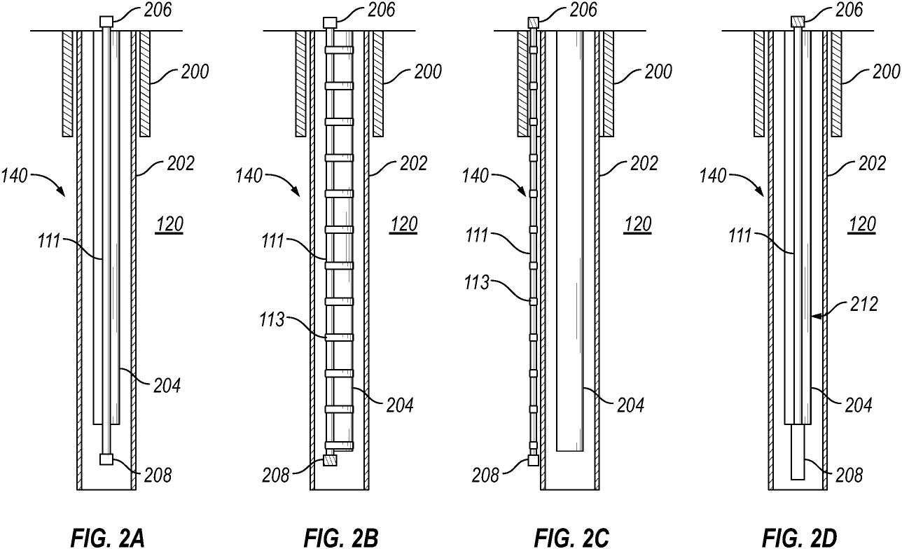

FIGS. 2A-2D illustrates different examples of deployment of fiber optic line 111 in hydraulic fracturing wellbore 114. As illustrated in FIG. 2A, wellbore 102 deployed in subterranean formation 120 may include surface casing 200 in which production casing 202 may be deployed. Additionally, production tubing 204 may be deployed within production casing 202. In this example, fiber optic line 111 may be temporarily deployed in a wireline system or directly within the interior of the casing. A bottom hole gauge 208 may be connected to the distal end of fiber optic line 111. Further illustrated, fiber optic line 111 may be coupled to a fiber connection 206. Fiber connection 206 may operate with an optical feedthrough system (itself comprising a series of wet- and dry-mate optical connectors) in the wellhead that may optically couple fiber optic line 111 from the tubing hanger to the wellheadinstrument panel.

FIG. 2B illustrates a permanent deployment of fiber optic line 111. As illustrated in hydraulic fracturing wellbore 114 deployed in subterranean formation 120 may include surface casing 200 in which production casing 202 may be deployed. Additionally, production tubing 204 may be deployedwithin production casing 202. In examples, fiber optic line 111 is attached to the outside of production tubing 204 by one or more cross-coupling protectors 210. Without limitation, cross-coupling protectors 210 may be evenly spaced and may be disposed on every other joint of production tubing 204. Further illustrated, fiber optic line 111 may be coupled to fiber connection 206 at one end and bottom hole gauge 208 at the opposite end.

FIG. 2C illustrates a permanent deployment of fiber optic line 111. As illustrated in hydraulic fracturing wellbore 114 deployed in subterranean formation 120 may include surface casing 200 in which production casing 202 may be deployed. Additionally, production tubing 204 may be deployedwithin production casing 202. In examples, fiber optic line 111 is attached to the outside of production casing 202 by one or more cross-coupling protectors 210. Without limitation, cross-coupling protectors 210 may be evenly spaced and may be disposed on every other joint of production tubing 204. Further illustrated, fiber optic line 111 may be coupled to fiber connection 206 at one end and bottom hole gauge 208 at the opposite end.

FIG. 2D illustrates a coiled tubing operation in which fiber optic line 111 may be deployed temporarily. As illustrated in FIG. 2D, hydraulic fracturing wellbore 114 deployed in subterranean formation 120 may include surface casing 200 in which production casing 202 may be deployed. Additionally, coiled tubing 212 may be deployed within production casing 202. In this example,fiber optic line 111 may be temporarily deployed in a coiled tubing system in which a bottomhole gauge 208 is connected to the distal end of downhole fiber. Further illustrated, fiber optic line 111 may be attached to coiled tubing 212, which may move fiber optic line 111 throughproduction casing 202. Further illustrated, fiber optic line 111 may be coupled to fiber connection 206 at one end and bottom hole gauge 208 at the opposite end. During operations, fiber optic line 111 may be used to take measurements within hydraulic fracturing wellbore 114, which may be transmitted to the surface for further processing.

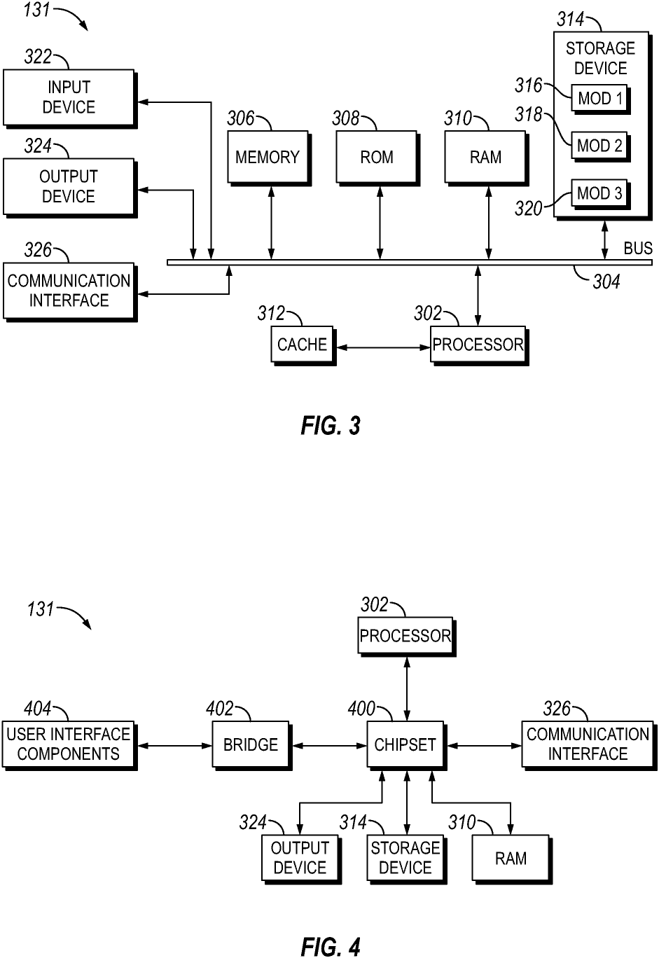

FIG. 3 illustrates an example information handling system 131 which may be employed to perform various steps, methods, and techniques disclosed herein. Persons of ordinary skill in the art will readily appreciate that other system examples are possible. As illustrated, information handling system 131 includes a processing unit (CPU or processor) 302 and a system bus 304 that couples various system components including system memory 306 such as read only memory (ROM) 308 and random-access memory (RAM) 310 to processor 302. Processors disclosed herein may all be forms of this processor 302. Information handling system 131 may include a cache 312 of high-speed memory connected directly with, in close proximity to, or integrated as part of processor 302. Information handling system 131 copies data from memory 306 and/or storage device 314 to cache 312 for quick access by processor 302. In this way, cache 312 provides a performance boost that avoids processor 302 delays while waiting for data. These and other modules may control or be configured to control processor 302 to perform various operations or actions. Other system memory 306 may be available for use as well. Memory 306 may include multiple different types of memory with different performance characteristics. It may be appreciated that the disclosure may operate on information handling system 131 with more than one processor 302 or on a group or cluster of computing devices networked together to provide greater processing capability. Processor 302 may include any general-purpose processor and a hardware module or software module, such as first module 316, second module 318, and third module 320 stored in storage device 314, configured to control processor 302 as well as a special-purpose processor where software instructions are incorporated into processor 302. Processor 302 may be a self-contained computing system, containing multiple cores or processors, a bus, memory controller, cache, etc. A multi-core processor may be symmetric or asymmetric. Processor 302 may include multiple processors, such as a system having multiple, physically separate processors in different sockets, or a system having multiple processor cores on a single physical chip. Similarly, processor 302 may include multiple distributed processors located in multiple separate computing devices but working together such as via a communications network. Multiple processors or processor cores may share resources such as memory 306 or cache 312 or may operate using independent resources. Processor 302 may include one or more state machines, an application specific integrated circuit (ASIC), or a programmable gate array (PGA) including a field PGA (FPGA).

Each individual component discussed above may be coupled to system bus 304, which may connect each and every individual component to each other. System bus 304 may be any of several types of bus structures including a memory bus or memory controller, a peripheral bus, and a local bus using any of a variety of bus architectures. A basic input/output (BIOS) stored in ROM 308 or the like, may provide the basic routine that helps to transfer information between elements within information handling system 131, such as during start-up. Information handling system 131 further includes storage devices 314 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 314 may include software modules 316, 318, and 320 for controlling processor 302. Information handling system 131 may include other hardware or software modules. Storage device 314 is connected to the system bus 304 by a drive interface. The drives and the associated computer-readable storage devices provide nonvolatile storage of computer-readable instructions, data structures, program modules and other data for information handling system 131. In one aspect, a hardware module that performs a particular function includes the software component stored in a tangible computer-readable storage device in connection with the necessary hardware components, such as processor 302, system bus 304, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 131 is a small, handheld computing device, a desktop computer, or a computer server. When processor 302 executes instructions to perform “operations”, processor 302 may perform the operations directly and/or facilitate, direct, or cooperate with another device or component to perform the operations.

As illustrated, information handling system 131 employs storage device 314, which may be a hard disk or other types of computer-readable storage devices which may store data that are accessible by a computer, such as magnetic cassettes, flash memory cards, digital versatile disks (DVDs), cartridges, random access memories (RAMs) 310, read only memory (ROM) 308, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 131, an input device 322 represents any number of input mechanisms, such as a microphone for speech, a touch-sensitive screen for gesture or graphical input, keyboard, mouse, motion input, speech and so forth. An output device 324 may also be one or more of a number of output mechanisms known to those of skill in the art. In some instances, multimodal systems enable a user to provide multiple types of input to communicate with information handling system 131. Communications interface 326 generally governs and manages the user input and system output. There is no restriction on operating on any particular hardware arrangement and therefore the basic hardware depicted may easily be substituted for improved hardware or firmware arrangements as they are developed.

As illustrated, each individual component describe above is depicted and disclosed as individual functional blocks. The functions these blocks represent may be provided through the use of either shared or dedicated hardware, including, but not limited to, hardware capable of executing software and hardware, such as a processor 302, that is purpose-built to operate as an equivalent to software executing on a general purpose processor. For example, the functions of one or more processors presented in FIG. 3 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

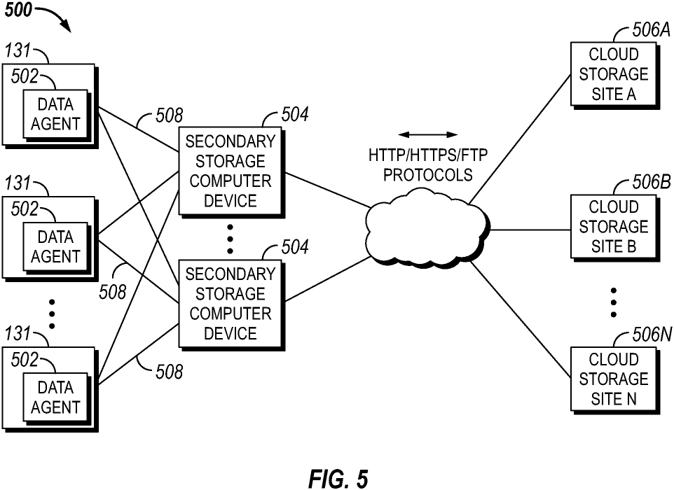

FIG. 4 illustrates an example information handling system 131 having a chipset architecture that may be used in executing the described method and generating and displaying a graphical user interface (GUI). Information handling system 131 is an example of computer hardware, software, and firmware that may be used to implement the disclosed technology. Information handling system 131 may include a processor 302, representative of any number of physically and/or logically distinct resources capable of executing software, firmware, and hardware configured to perform identified computations. Processor 302 may communicate with a chipset 400 that may control input to and output from processor 302. In this example, chipset 400 outputs information to output device 324, such as a display, and may read and write information to storage device 314, which may include, for example, magnetic media, and solid-state media. Chipset 400 may also read data from and write data to RAM 310. A bridge 402 for interfacing with a variety of user interface components 404 may be provided for interfacing with chipset 400. Such user interface components 404 may include a keyboard, a microphone, touch detection and processing circuitry, a pointing device, such as a mouse, and so on. In general, inputs to information handling system 131 may come from any of a variety of sources, machine generated and/or human generated.

Chipset 400 may also interface with one or more communication interfaces 326 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 302 analyzing data stored in storage device 314 or RAM 310. Further, information handling system 131 receive inputs from a user via user interface components 404 and execute appropriate functions, such as browsing functions by interpreting these inputs using processor 302.

In examples, information handling system 131 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

During hydraulic fracturing operations, information handling system 131 may process different types of the real time data originated from varied sampling rates and various sources, such as diagnostics data, sensor measurements, operations data, and or the like, such as pumping rates, proppant concentration, and wellhead pressures measured at hydraulic fracturing wellbore 114 and fiber optic measurements gathered from DAS system 107. These measurements from hydraulic fracturing wellbore 114 and DAS system 107 may allow for information handling system 131 to perform real-time health assessment of the hydraulic fracturing operation.

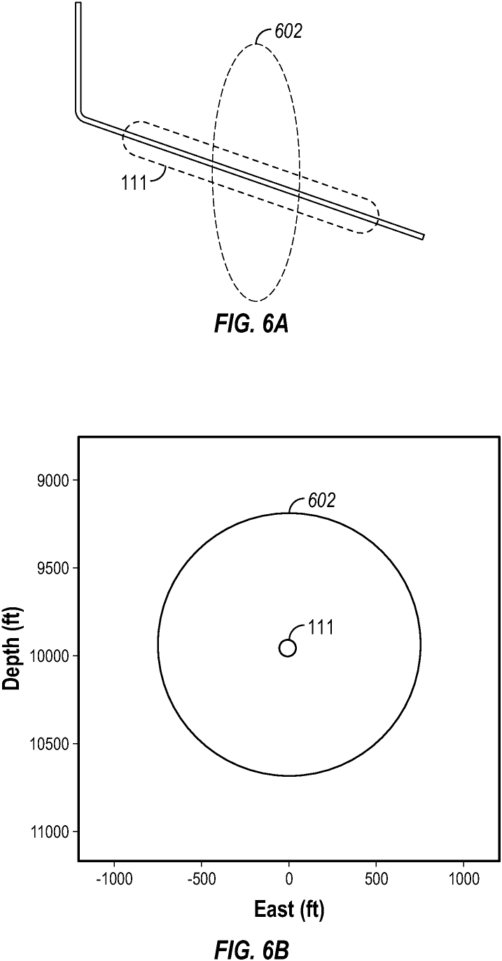

FIG. 5 illustrates an example of one arrangement of resources in a computing network 400 that may employ the processes and techniques described herein, although many others are of course possible. As noted above, an information handling system 131, as part of their function, may utilize data, which includes files, directories, metadata (e.g., access control list (ACLS) creation/edit dates associated with the data, etc.), and other data objects. The data on the information handling system 131 is typically a primary copy (e.g., a production copy). During a copy, backup, archive or other storage operation, information handling system 131 may send a copy of some data objects (or some components thereof) to a secondary storage computing device 504 by utilizing one or more data agents 502.

A data agent 502 may be a desktop application, website application, or any software-based application that is run on information handling system 131. As illustrated, information handling system 131 may be disposed at any rig site (e.g., referring to FIG. 1) or repair and manufacturing center. The data agent may communicate with a secondary storage computing device 504 using communication protocol 508 in a wired or wireless system. Information handling system 131 may utilize communication protocol 508 to access processed measurements from fiber optic line 111. Such types of processed measurements may include seismic travel time from microseismic events. Additionally, any other processed measurement may be acquired from fiber optic line 111 and implemented with communication protocol 508. These processed measurements are accessed from secondary storage computing device 504 by data agent 502, which is loaded on information handling system 131.

Secondary storage computing device 504 may operate and function to create secondary copies of primary data objects (or some components thereof) in various cloud storage sites 506AN. Additionally, secondary storage computing device 504 may run determinative algorithms on data uploaded from one or more information handling systems 131, discussed further below. Communications between the secondary storage computing devices 504 and cloud storage sites 506A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 506A-N, the secondary storage computing device 504 may also perform local content indexing and/or local object-level, sub-object-level or block-level deduplication when performing storage operations involving various cloud storage sites 506A-N. Cloud storage sites 506A-N may further record and maintain DTC code logs for each downhole operation or run, map DTC codes, store repair and maintenance data, store operational data, and/or provide outputs from determinative algorithms that are located in cloud storage sites 506A-N. In a non-limiting example, this type of network may be utilized as a platform to store, backup, analyze, import, and preform extract, transform and load (“ETL”) processes to the data gathered during a hydraulic fracturing operation.

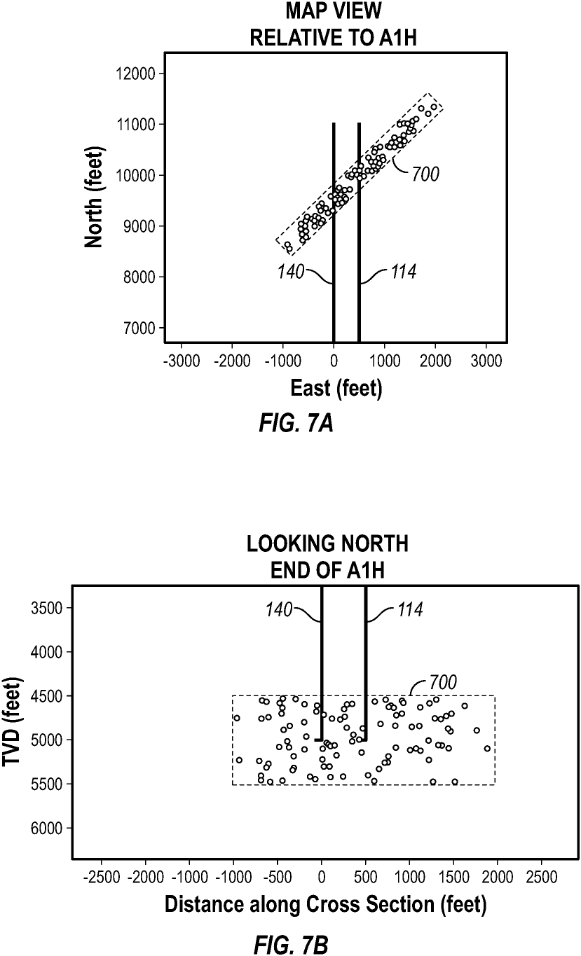

FIG. 6A illustrates a probability density function (PDF) 602 of a microseismic event source location measured by fiber optic line 111 (e.g., referring to FIG. 1) in an oblique view. PDF 602 may be defined by a function which yields the probability of a microseismic event occurring in each location provided by the function. In this particular example PDF 602 is defined by a 3D volume surrounding fiber optic line 111. The position of the microseismic event may be oriented around fiber optic line 111 such that the location of the microseismic event doesn’t coincide with the axis of fiber optic line 111. The radial distance of the microseismic event to fiber optic line 111 may be determined, but since a fiber optic line 111 (e.g., referring to FIG. 1) may be directionally insensitive, a single fiber optic line 111 alone may not be able to determine the azimuthal position of the microseismic event around fiber optic line 111. Without further information, which may include a priori information, the solution may be non-unique, in that every point on PDF 602 may be equally likely. A priori information which may help pinpoint a location of the microseismic event may include, but is not limited to, geological knowledge regarding basin stress orientation. Therefore, the 3D shape of PDF 602 for a homogenous, non-laminated, isotropic subterranean formation may generally be that of a circle or an ellipse. For laminated, heterogeneous, or anisotropic subterranean formations, the PDF 602 may be more arc-like in shape. Additionally, multiple microseismic events may be measured by fiber optic line 111. FIG. 6B illustrates PDF 602 a cross-sectional or a gun barrel view. With the provided view, PDF 602 can be shown to have symmetry and equiprobability of the solution for the homogeneous systems.

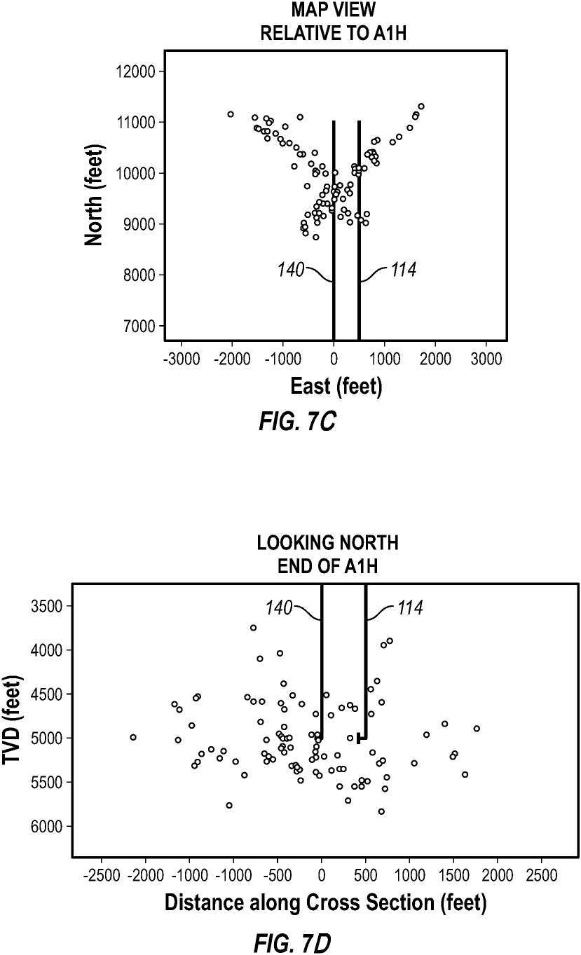

FIG. 7A illustrates a microseismic event cloud 700 which may be derived by selecting and compiling the correct presumed location of one or more microseismic events from the associated PDFs 602. Each individually measured microseismic event may take the form of PDFs 602 (e.g., referring to FIG. 6A), to be described below. By use of a priori knowledge, a compilation of the most probable locations of the microseismic events from each PDF 602 may be utilized to construct microseismic event cloud 700. FIG. 7A illustrates a birds-eye-view of microseismic event cloud 700, whereas FIG. 7B illustrates a cross-sectional view of microseismic event cloud 700. Microseismic cloud 700 may delineate the extent of hydraulic fracture propagation. Microseismic cloud may take an elongated shape, which may be approximated by a cuboid or an ellipsoid and described by the cuboid’s orientation, length, width, and height.

FIGS. 7A and 7B illustrate microseismic event cloud 700, which is a curated subset of the directionally-insensitive, raw data where the subset may include the correctly identified location of the microseismic events. Prior to applying techniques which may properly identify the actual locations of the one or more microseismic events that have been measured, the raw dataset may include microseismic event locations that are improbable with respect to the expected fracture orientation of the basin. Examples of the directionally-insensitive raw measurements are depicted with a birds-eye-view perspective in FIG. 7C and with a cross-sectional perspective in FIG. 7D oriented around wellbore 114 and wellbore 140.

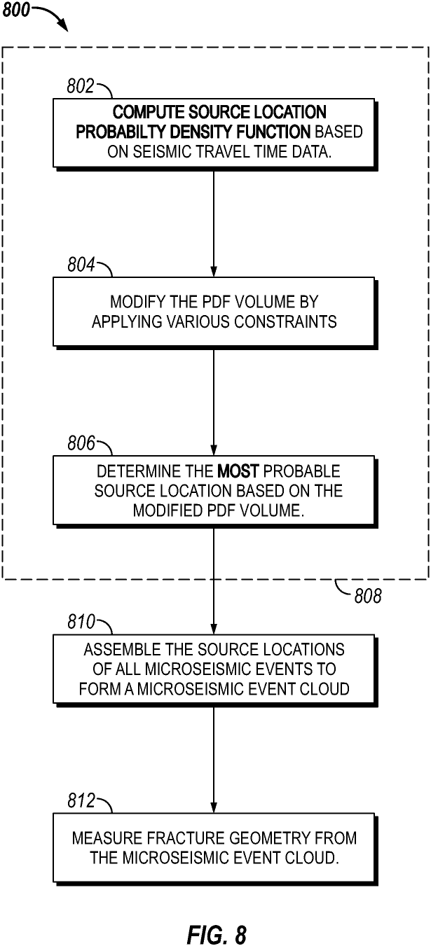

FIG. 8 illustrates an example workflow 800 which may be used to locate, monitor, assess, and/or store data pertaining to one or more microseismic events, which further involve compiling and storing data which may be executed on an information handling system 131. In workflow 800 only a single fiber optic line 111 (e.g., referring to FIG. 1) is utilized for microseismic monitoring. As previously described, with single fiber microseismic monitoring the true location of a microseismic source may not be uniquely pinpointed from raw data alone without further information. Instead, the location may be better-described by a PDF applied to a 3D volume. The point in the 3D volume with the maximum PDF value (i.e., the highest likelihood) x* is selected and reported as the source location in equation (1):

$$x ✽ = a r g m a x P D F \left(x\right)$$

The shape of the PDF volume may be situationally dependent. If the fiber trajectory is perfectly straight and if the subterranean formation is presumed to be generally homogenous, which may result in utilizing a homogenous velocity model to locate the seismic event source, then the resulting PDF 602 (e.g., referring to FIG. 6A) may take the shape of a ring. However, other suitable shapes of PDF volumes may result with the use of in-homogenous velocity models which may include arcs and ellipses. Equation (1) is applied within block 802 to compute a source location from a PDF which may be constructed from seismic travel time data obtained from fiber optic line 111. Seismic travel time is defined as the time it takes for a pressure wave to travel to fiber optic line 111 from an acoustic response to a microseismic event. A microseismic event may be defined as a micro fault, micro fracture, micro deformation, or extension of the hydraulic fracture network has occurred. A microseismic event may be defined between a Richter magnitude of -3 to 0, with an acoustic response between 50 and 500 Hz, and dimensions between 1 mm and 10 m. Generally, microseismic events are caused by human operation and designed to identify formation properties. Microseismic events may originate from a subterranean formation or at the surface.

In block 804 the original PDF 602 (e.g., referring to FIG. 6A) from block 802 is modified in different examples. Each example modifies the original PDF 602 by an additional term that arises from some physical constraint of independent data, which may be expressed in Equation (2):

$$P D F \left(x\right) = P D {F}_{0} ∗ P D {F}_{1}$$

where x = (x, y, z) is a point in 3D space, PDF₀(x) is the original PDF based on data alone, PDF₁(x) the additional term which may be various constraints in multiple examples provided below, and PDF(x) the modified PDF.

The effect of the additional term, PDF₁(x) may be varied by altering the term with a weighting factor, w₁ which may be determined empirically or via a machine-learning algorithm. The altered additional term may be defined in Equation (3):

$$P D {F}_{1} \left(x\right) = 1 - {w}_{1} \left(1 - P D {F}_{1} \left(x\right)\right)$$

if weight w₁ is equal to 1, the term has the full effect, and if w1 is equal to 0, the additional term has no effect. Equation (3) applies a nonhomogeneous velocity model which may form arc shaped PDFs.

In a first example of block 804, modifying the original PDF by considering the proximity to the current stage’s perf center position constraint by applying Equation (4):

$$P D {F}_{1} \left(x\right) = {e}^{- \frac{1}{2}} {}^{{\left(\frac{{}^{x - x} p e r f}{Δ x}\right)}^{2}}$$

where x_{perf} is the centroid of the perforation cluster for the current stage, and Δx is a value affecting the broadness of the PDF shape. For example, it may be chosen as a maximal distance from the expected event to the perforation based on a priori information or knowledge gained from the previous stages. Let (xᵢ, yᵢ, zᵢ) be the position of the ith perf cluster, then “perf center position” (x_{c}, y_{c}, z_{c}) is their average: x_{c} = sumᵢ(xᵢ)/n, y_{c} = sumᵢ(yᵢ)/n, and z_{c} = sumᵢ(zᵢ)/n where n is the total number of perf clusters.

In a second example of block 804, the original PDF 602 (e.g., referring to FIG. 6A) is modified by a vertical depth constraint. It may be observed that microseismic events occur more frequently in certain formation layers (vertical depth ranges) than in others. Therefore Equation (5) may be applied:

$$P D {F}_{1} \left(x , y , z\right) = f \left(z\right)$$

where ƒ(z) is a function that characterizes the likelihood of a microseismic event occurring at vertical depth z. The function f(z) may be determined empirically from data (i.e., constructed from previous microseismic monitoring jobs in the same or similar region or from previous stages in the current job). For example, in a simplified case, ƒ(z) may be equal to 1 if z is within a specific depth range [zₘᵢₙ, z_{max]}; and 0, otherwise. The depth range may be dependent on the likelihood that a fracture is going to grow out of zone from where the fracture was initiated through perforation methods. If a strong and/or thick impermeable bounding layer (ex: thick shale, anhydrite, gypsum, or other evaporitic rock layer) is above or below the fracturing operation, then the fracture may grow out of zone, upward and/or downward, in the z-direction. This type of information may be accumulated based on the geology of the area and geological experience gathered from prior operations. Additionally, the information may be assumed from well log and mud logs in the rare case of a wild cat well.

In a third example of block 804, the original PDF is modified by an azimuth constraint. The dominant azimuth of hydraulic fracture may follow the minimal principal stress orientation of the formation being fractured. It is reasonable to expect microseismic event cloud 700 to follow the same direction. One implementation is to set the additional PDF term in equation (6):

$$P D {F}_{1} \left(x\right) = f \left(α \left(x , {x}_{p e r f}\right)\right)$$

where α is the azimuth angle measured from the current stage’s perf center position to point x. ƒ(α) may take the form ƒ(α) = 1, if α is within a certain range [αₘᵢₙ, α_{max]}; and 0, otherwise. The azimuth range of acceptance may be defined as an interval ± 5 degrees around an expected azimuth value α₀. The expected azimuth value α₀ may be determined from the direction of minimal principal stress orientation or trends observed in historical data (i.e., previous microseismic jobs or previous stages in the current job). Furthermore, α₀ may be computed in real-time using microseismic data or using another sensing technology, such as crosswell strain analysis. In one example, axial position (l) and radius (r) of the “ring” associated with each microseismic event that have been captured by fiber optic line 111, are computed and stored. Subsequently, a linear fit is performed on the l vs r dataset. The direction of the fitted line may be used to approximate α₀. In another example, the PDF₀(x) of the microseismic events that have been captured by fiber optic line 111, are computed and stored. Subsequently, all the PDF₀ are summed up, and a principal component analysis (PCA) is performed on the summed PDF₀, and the azimuth of the primary eigenvector is used to approximate α₀.

In a fourth example of block 804, the original PDF 602 (e.g., referring to FIG. 6A) is modified to be expressed as an expected microseismic volume (EMV). In this example the EMV may be defined by one or more of these attributes: origin position, shape, orientation, size, and hydraulic fracture treatment parameters. The EMV may be used to represent the expected spatial extent of the microseismic cloud. A microseismic event is considered more likely to occur within this volume than outside. The additional PDF term may be set by equation (7):

$$P D {F}_{1} \left(x\right) = \left\{\begin{matrix}1 , & i f x i s c o n t a i n e d b y t h e v o l u m e \\ 0 , & e l s e\end{matrix}\right)$$

the shape of the EMV may be an ellipsoid, a cuboid, or an asymmetrical/irregular shape. Furthermore, the EMV may be the union of several simple-shaped volumes.

In a fifth example of block 804, the original PDF may be modified in a similar manner to the foregoing example with the exception that the attributes (ex: origin position, shape, orientation, and size) of the volume may change as a function of time. Modification may allow for the removal of results that may be identified as not being correct. For example, the size of the volume may grow as a function of the elapsed time since the start of treatment.

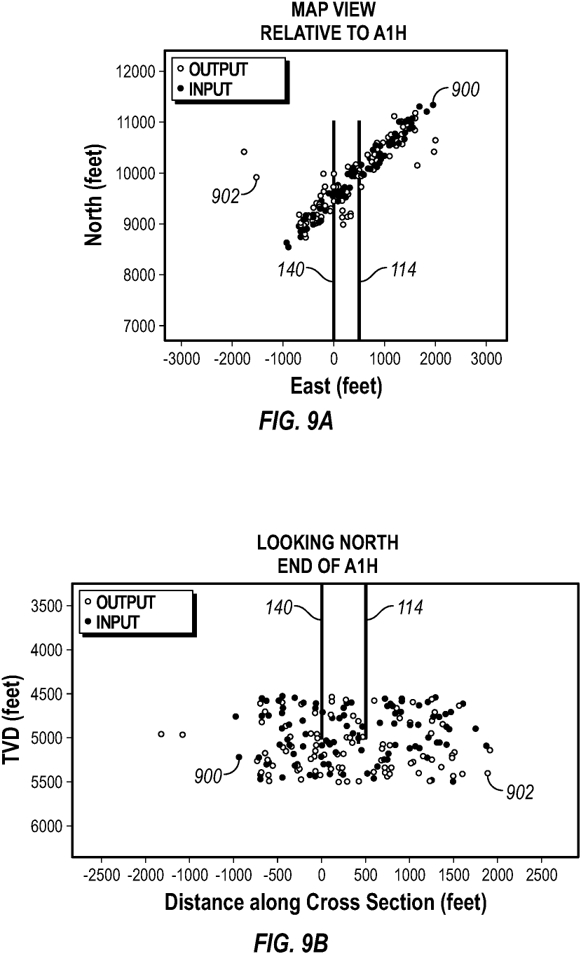

FIGS. 9A and 9B illustrate the results of combining the second and third examples of block 804. FIG. 9A illustrates a birds-eye-view, whereas FIG. 9B illustrates a cross-sectional view. In each figure, markings 900 indicate previously determined input microseismic event cloud as illustrated Figured 7A and 7B, while markings 902 indicate output microseismic event cloud by applying examples 2 and 3 from block 804. The output-markings 902 cloud closely resembles the input- markings 900 in terms of orientation and size.

Additionally, any combination of the five examples, in any order may be applied at block 804. In such cases Equation (8) may be applied:

$$P D F \left(x\right) = P D {F}_{0} \left(x\right) ∗ \prod {}_{i = 1}^{N} P D {F}_{i} \left(x\right)$$

where PDFᵢ(x) is the modification introduced by the ith method. Further, modification may be applied in forms other than multiplication. For example, in Equation (9):

$$P D F \left(x\right) = {w}_{0} P D {F}_{0} \left(x\right) + \sum {}_{i = 1}^{N} {w}_{i} P D {F}_{i} \left(x\right)$$

Equations (8) and (9) may allow for multiple methods to be applied as a serial addition or multiplication or a mixture of both.

Referring back to FIG. 8, in block 806 the most probable value solution for the microseismic event location may be selected from the modified PDF. Alternatively, a percentage or raw value cut-off may be applied which may select a multiplicity of the most probable solutions rather than the single highest solution. Accordingly, the assembled microseismic cloud is a PDF value-weighted sum of all the candidate solutions of all events. The cloud may have some outliers, often with low PDF density. When measuring fracture geometry from the cloud, an outlier-exclusion algorithm may be applied.

The methods are designed to work for a single fiber microseismic monitoring scenario, but they may also be applied to the case of multiple fiber monitoring, or microseismic monitoring using other kinds of seismic sensors (e.g., geophones, hydrophones) alone, or in combination with fiber monitoring. Iteration 808 applies to blocks 802, 804, and 806. Specifically, iteration 808 confirms the previously mentioned steps are individually undertaken for each microseismic event. Utilizing each source location from block 806, a microseismic event cloud 700 (e.g., referring to FIG. 7) may be assembled in block 810. If an in-homogeneous velocity model is applied to modify PDFs as described in block 804, useful and/or informative microseismic event clouds 700, such as FIGS. 7A and 7B may be assembled. Such microseismic event clouds 700 may be used in block 812 to measure or estimate fracture geometry.

Utilizing these systems methods may be beneficial for measuring fracture geometry. Additionally, the disclosed systems and methods are improvements over the current art. For example, in current art, the ambiguity inherent in DAS microseismic event location often results in microseismic event clouds which do not match the true shape of the seismic activity. They include abnormal distortions or geometric artifacts which are non-physical. Interpretation of these poor event clouds may lead to incorrect fracture geometry measurement leading to poor fracture-optimization decisions. By comparison this invention generates superior microseismic event clouds which are truer to the expected pattern of seismic activity. The event clouds permit more reasonable fracture geometries to be computed, leading to improved fracture optimization decisions and, ultimately, better business outcomes. The systems and methods may include any of the various features disclosed herein, including one or more of the following statements.

Statement 1: The method may comprise measuring a seismic travel time of a microseismic event with a fiber optic line disposed in a first wellbore; forming a probability density function for the microseismic event based at least in part on the seismic travel time measurement; modifying the probability density function by applying one or more constraints to form a modified probability density function; identifying one or more most probable source locations from the modified probability density function; and forming a microseismic event cloud from the one or more most probable source locations.

Statement 2. The method of statement 1, further comprising identifying a fracture geometry from the microseismic event cloud.

Statement 3. The method of statement 1, wherein the probability density function is circular, elliptical, arced, a volume in a three-dimensional space, or any combination thereof.

Statement 4. The method of statement 1, wherein the modified probability density function is expressed as an expected microseismic volume.

Statement 5. The method of statement 4, wherein the expected microseismic volume is shaped as an ellipsoid, a cuboid, or an asymmetrical shape.

Statement 6. The method of statement 4, wherein the expected microseismic volume is shaped as an ellipsoid, a cuboid, or an asymmetrical shape.

Statement 7. The method of statement 4, wherein the expected microseismic volume is defined by one or more attributes.

Statement 8. The method of statement 6, wherein the one or more attributes are origin position, shape, orientation, or size.

Statement 9. The method of statement 6, wherein the one or more attributes are expressed as a function of hydraulic fracture treatment parameters.

Statement 10. The method of statement 1, further comprising measuring the seismic travel time with one or more fiber optic lines in a second wellbore.

Statement 11. The method of statement 1, wherein the one or more constraints comprises an azimuth measurement, a vertical depth range, or a distance to an expected fracture initiation point, such as a perforation-cluster centroid position of a hydraulic fracture treatment stage.

Statement 12. A system comprising a fiber optic line disposed in a first wellbore and configured to measure a seismic travel time of a microseismic event; an information handling system configured to: form a probability density function for the microseismic event based at least in part on the seismic travel time; modify the probability density function by applying one or more constraints to form a modified probability density function; identify one or more most probable source locations from the modified probability density function; and form a microseismic event cloud from the one or more most probable source locations.

Statement 13. The system of statement 12, wherein the information handling system is further configured to identify a fracture geometry from the microseismic event cloud.

Statement 14. The system of statement 12, wherein the probability density function is circular, elliptical, arced, a volume in a three-dimensional space, or any combination thereof.

Statement 15. The system of statement 12, wherein the modified probability density function is expressed as an expected microseismic volume.

Statement 16. The system of statement 15, wherein the expected microseismic volume is shaped as an ellipsoid, a cuboid, or an asymmetrical shape.

Statement 17. The system of statement 15, wherein the expected microseismic volume is defined by one or more attributes.

Statement 18. The system of statement 17, wherein the one or more attributes are origin position, shape, orientation, or size.

Statement 19. The system of statement 17, wherein the one or more attributes are expressed as a function of time.

Statement 20. The system of statement 17, wherein the one or more attributes are expressed as a function of hydraulic fracture treatment parameters.

Statement 21. The system of statement 12, wherein the one or more constraints comprises an azimuth measurement, a vertical depth range, or a distance to an expected fracture initiation point, such as perforation-cluster centroid position of a hydraulic fracture treatment stage.

Statement 22. The system of statement 12, further comprising one or more fiber optic lines disposed in a second wellbore.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
measuring a seismic travel time of a microseismic event with a fiber optic line disposed in a first wellbore;
forming a probability density function for the microseismic event based at least in part on the seismic travel time measurement;
modifying the probability density function by applying one or more constraints to form a modified probability density function;
identifying one or more most probable source locations from the modified probability density function; and
forming a microseismic event cloud from the one or more most probable source locations.

2. The method of claim 1, further comprising identifying a fracture geometry from the microseismic event cloud.

3. The method of claim 1, wherein the probability density function is circular, elliptical, arced, a volume in a three-dimensional space, or any combination thereof.

4. The method of claim 1, wherein the modified probability density function is expressed as an expected microseismic volume.

5. The method of claim 4, wherein the expected microseismic volume is shaped as an ellipsoid, a cuboid, or an asymmetrical shape.

6. The method of claim 4, wherein the expected microseismic volume is defined by one or more attributes.

7. The method of claim 6, wherein the one or more attributes are origin position, shape, orientation, or size.

8. The method of claim 6, wherein the one or more attributes are expressed as a function of time.

9. The method of claim 6, wherein the one or more attributes are expressed as a function of hydraulic fracture treatment parameters.

10. The method of claim 1, further comprising measuring the seismic travel time with one or more fiber optic lines in a second wellbore.

11. The method of claim 1, wherein the one or more constraints comprises an azimuth measurement, a vertical depth range, or a distance to an expected fracture initiation point, such as a perforation-cluster centroid position of a hydraulic fracture treatment stage.

12. A system comprising:
a fiber optic line disposed in a first wellbore and configured to measure a seismic travel time of a microseismic event;
an information handling system configured to:
form a probability density function for the microseismic event based at least in part on the seismic travel time;
modify the probability density function by applying one or more constraints to form a modified probability density function;
identify one or more most probable source locations from the modified probability density function; and
form a microseismic event cloud from the one or more most probable source locations.

13. The system of claim 12, wherein the information handling system is further configured to identify a fracture geometry from the microseismic event cloud.

14. The system of claim 12, wherein the probability density function is circular, elliptical, arced, a volume in a three-dimensional space, or any combination thereof.

15. The system of claim 12, wherein the modified probability density function is expressed as an expected microseismic volume.

16. The system of claim 15, wherein the expected microseismic volume is shaped as an ellipsoid, a cuboid, or an asymmetrical shape.

17. The system of claim 15, wherein the expected microseismic volume is defined by one or more attributes.

18. The system of claim 17, wherein the one or more attributes are origin position, shape, orientation, or size.

19. The system of claim 17, wherein the one or more attributes are expressed as a function of time.

20. The system of claim 17, wherein the one or more attributes are expressed as a function of hydraulic fracture treatment parameters.

21. The system of claim 12, wherein the one or more constraints comprises an azimuth measurement, a vertical depth range, or a distance to an expected fracture initiation point, such as perforation-cluster centroid position of a hydraulic fracture treatment stage.

22. The system of claim 12, further comprising one or more fiber optic lines disposed in a second wellbore.
